(19) United States
(12) Patent Application Publication
(10) Pub. No.: US 2026/0175719 A1
(43) Pub. Date: Jun. 25, 2026

(54) MULTIFUNCTIONAL CHARGER AND AUXILIARY POWER MODULE COMBINATION USING INVERTER

(71) Applicant: GM Global Technology Operations LLC, Detroit, MI (US)

(72) Inventors: Rashmi Prasad, Troy, MI (US); Chandra S. Namuduri, Troy, MI (US)

(21) Appl. No.: 18/987,131

(22) Filed: Dec. 19, 2024

(51) Int. Cl. B60L 53/20; B60K 1/02; B60L 50/60

(52) U.S. Cl. CPC B60L 53/20; B60L 50/60; B60K 1/02; B60L 2210/10; B60L 2210/30

(57) ABSTRACT

An electric vehicle includes an electrical system. The electric system includes a high voltage power source, a low voltage power source, an inverter coupled to the high voltage power source, a motor coupled to the inverter, and a multi-port DC/DC converter. The motor is configured to couple to an AC grid. The multi-port DC/DC converter includes a transformer, a first AC/DC converter having a first DC-side configured to couple to the high voltage power source and a first AC-side coupled to the transformer, a second AC/DC converter having a second AC-side coupled to the transformer and a second DC-side configured to couple to the high voltage power source, a third AC/DC converter having a third AC-side coupled to the transformer and a third DC-side coupled to the low voltage power source, and a processor configured to control a configuration between the motor, the multi-port DC/DC converter and the AC grid.

The subject disclosure relates to vehicles and, in particular, to a system and method for operating an electrical system of the vehicle using a multi-port direct current (DC)/DC converter that integrates an On-Board Charging Module with an Auxiliary Power Module.

An electric vehicle includes various modules for operating the vehicle and for charging the vehicle. An On-Board Chargin Module (OBCM) controls the rate and power at which a battery of the vehicle is charged. An Auxiliary Power Module (APM) provides power from a low voltage battery to low voltage electrical loads. The OBCM is not needed during a propulsion mode of the vehicle and only provides dead weight to the vehicle during this mode. Both the OBCM and the APM take up space that can be used for other components of the vehicle. Accordingly, it is desirable to provide a system that integrates the OBCM and the APM with reduced size.

### SUMMARY

In one exemplary embodiment, an electrical system of a vehicle is disclosed. The electrical system includes a motor configured to couple to an alternating current (AC) grid and a multi-port direct current/direct current (DC/DC) converter. The multi-port DC/DC converter includes a transformer, a first alternating current/direct current (AC/DC) converter having a first DC-side configured to couple to a high voltage power source and a first AC-side coupled to the transformer, a second AC/DC converter having a second AC-side coupled to the transformer and a second DC-side configured to couple to the high voltage power source, a third AC/DC converter having a third AC-side coupled to the transformer and a third DC-side coupled to a low voltage power source, and a processor configured to control a configuration between the motor, the multi-port DC/DC converter and the AC grid.

In addition to one or more of the features described herein, the motor further includes a neutral point and a half-bridge synchronous rectifier including a midpoint, wherein the neutral point is configured to connect to a positive grid bus of the AC grid and the midpoint is configured to connect to a negative grid bus of the AC grid.

In addition to one or more of the features described herein, the motor includes a first phase wire configured to connect to a positive grid bus of the AC grid and an inverter including a first phase leg associated with the first phase wire, wherein the first phase leg is configured to connect to negative grid bus of the AC grid.

In addition to one or more of the features described herein, the motor includes a first phase wire configured to connect to a positive grid bus of the AC grid and a half-bridge synchronous rectifier having a midpoint, wherein the midpoint is configured to connect to a negative grid bus of the AC grid.

In addition to one or more of the features described herein, the motor includes a first motor having a first neutral point and a second motor having a second neutral point, wherein the first neutral point is configured to connect to a positive grid bus of the AC grid and the second neutral point is configured to connect to a negative grid bus of the AC grid.

In addition to one or more of the features described herein, the electrical system further includes a first converter switch between the high voltage power source and the first AC/DC converter, a positive OBCM switch and a negative OBCM switch between the third AC/DC converter and the high voltage power source, a positive HV switch and a negative HV switch between the high voltage power source and the motor, and a first grid switch and second grid switch of the AC grid.

In addition to one or more of the features described herein, in a propulsion mode, the first converter switch, the positive On-Board Chargin Module (OBCM) switch and the negative OBCM switch are open and the positive high voltage (HV) switch and the negative HV switch are closed.

In addition to one or more of the features described herein, in a pre-charging mode, the OBCM positive switch, the OBCM negative switch are open, and the first converter switch, the positive HV switch and the negative HV switch are closed.

In addition to one or more of the features described herein, in a charging mode, the positive HV switch and the negative HV switch are open, and the first converter switch, the positive OBCM switch, the negative OBCM switch, the first grid switch and second grid switch are closed.

In addition to one or more of the features described herein, in a vehicle-to-everything mode, the positive HV switch and negative HV switch 312 are open, and the first converter switch, the positive OBCM switch and the negative OBCM switch are closed.

In another exemplary embodiment, an electric vehicle is disclosed. The electric vehicle includes a high voltage power source, a low voltage power source, an inverter coupled to the high voltage power source, a motor coupled to the inverter, wherein the motor is configured to couple to an alternating current (AC) grid, and a multi-port direct current/direct current (DC/DC) converter. The multi-port DC/DC converter includes a transformer, a first alternating current/direct current (AC/DC) converter having a first DC-side configured to couple to the high voltage power source and a first AC-side coupled to the transformer, a second AC/DC converter having a second AC-side coupled to the transformer and a second DC-side configured to couple to the high voltage power source, a third AC/DC converter having a third AC-side coupled to the transformer and a third DC-side coupled to the low voltage power source, and a processor configured to control a configuration between the motor, the multi-port DC/DC converter and the AC grid.

In addition to one or more of the features described herein, the motor further includes a neutral point and a half-bridge synchronous rectifier including a midpoint, wherein the neutral point is configured to connect to a positive grid bus of the AC grid and the midpoint is configured to connect to a negative grid bus of the AC grid.

In addition to one or more of the features described herein, the motor includes a first phase wire configured to connect to a positive grid bus of the AC grid and the inverter includes a first phase leg associated with the first phase wire, wherein the first phase leg is configured to connect to negative grid bus of the AC grid.

In addition to one or more of the features described herein, the motor includes a first phase wire configured to connect to a positive grid bus of the AC grid and a half-bridge synchronous rectifier having a midpoint, the midpoint configured to connect configured to connect to a negative grid bus of the AC grid.

In addition to one or more of the features described herein, the motor includes a first motor having a first neutral point and a second motor having a second neutral point, wherein the first neutral point is configured to connect to a positive grid bus of the AC grid and the second neutral point is configured to connect to a negative grid bus of the AC grid.

In addition to one or more of the features described herein, the elective vehicle further includes a first converter switch between the high voltage power source and the first AC/DC converter, a positive On-Board Chargin Module (OBCM) switch and a negative OBCM switch between the third AC/DC converter and the high voltage power source, a positive high voltage (HV) switch and a negative HV switch between the high voltage power source and the motor, and a first grid switch and second grid switch of the AC grid.

In addition to one or more of the features described herein, in a propulsion mode, the first converter switch, the positive OBCM switch and the negative OBCM switch and are open and the positive HV switch and the negative HV switch are closed.

In addition to one or more of the features described herein, in a pre-charging mode, the OBCM positive switch, the OBCM negative switch are open, and the first converter switch, the positive HV switch and the negative HV switch are closed.

In addition to one or more of the features described herein, in a charging mode, the positive HV switch and the negative HV switch are open, and the first converter switch, the positive OBCM switch, the negative OBCM switch, the first grid switch and second grid switch are closed.

In addition to one or more of the features described herein, in a vehicle-to-everything mode, the positive HV switch and negative HV switch 312 are open, and the first converter switch, the positive OBCM switch and the negative OBCM switch are closed.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows an electric vehicle in an exemplary embodiment;

FIG. 2 is a schematic diagram of an electrical system of the vehicle of FIG. 1;

FIG. 3 is a detailed view of an electrical system of the vehicle in one embodiment;

FIG. 4 is a detailed view of an electrical system of the vehicle, in another embodiment;

FIG. 5 is a detailed view of an electrical system of the vehicle, in yet another embodiment; and

FIG. 6 is a detailed view of an electrical system of the vehicle, in yet another embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features.

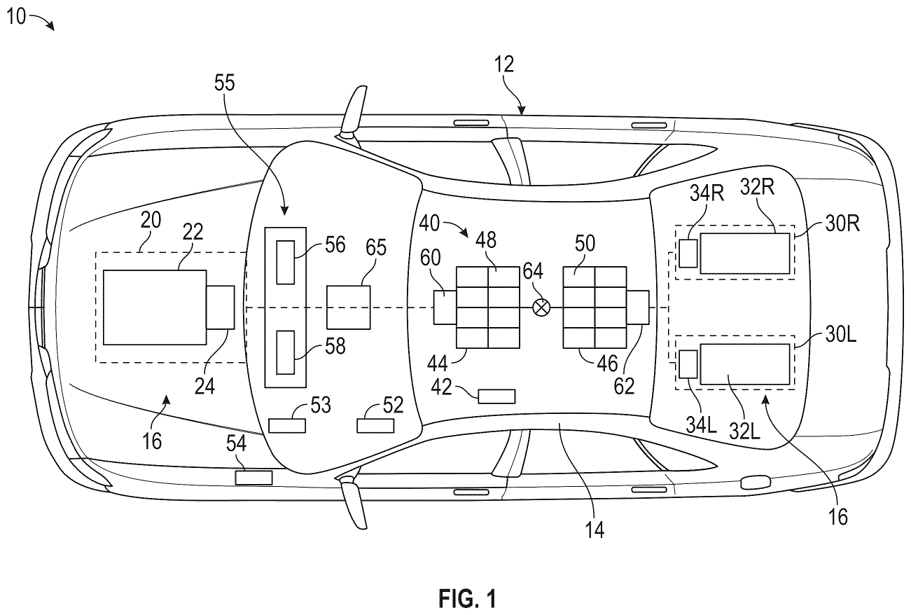

In accordance with an exemplary embodiment, FIG. 1 shows a vehicle 10, which includes a vehicle body 12 defining, at least in part, an occupant compartment 14. The vehicle body 12 also supports various vehicle subsystems including a propulsion system 16, and other subsystems to support functions of the propulsion system 16 and other vehicle components, such as a braking subsystem, a suspension system, a steering subsystem, and others.

The vehicle 10 may be an electrically powered vehicle (EV), a hybrid vehicle or any other vehicle. In an embodiment, the vehicle 10 is an electric vehicle that includes multiple motors and/or drive systems. Any number of drive units may be included, such as one or more drive units for applying torque to front wheels (not shown) and/or to rear wheels (not shown). The drive units are controllable to operate the vehicle 10 in various operating modes, such as a normal mode, a high-performance mode (in which additional torque is applied), all-wheel drive (“AWD”), front-wheel drive (“FWD”), rear-wheel drive (“RWD”) and others.

For example, the propulsion system 16 is a multi-drive system that includes a front drive unit 20 for driving front wheels, and rear drive units for driving rear wheels. The front drive unit 20 includes a front electric motor 22 and a front inverter 24 (e.g., front power inverter module or FPIM), as well as other components such as a cooling system. A left rear drive unit 30L includes a left rear electric motor 32L and a left rear inverter 34L. A right rear drive unit 30R includes a right rear electric motor 32R and a right rear inverter 34R. The front inverter 24, left rear inverter 34L and right rear inverter 34R (e.g., power inverter units or PIMs) each convert direct current (DC) power from a high voltage (HV) battery system 40 to poly-phase (e.g., two-phase, three-phase, six-phase, etc.) alternating current (AC) power to drive the front electric motor 22 the left rear electric motor 32L and the right rear electric motor 32R.

As shown in FIG. 1, the drive systems feature separate electric motors. However, embodiments are not so limited. For example, instead of separate motors, multiple drives can be provided by a single machine that has multiple sets of windings that are physically independent.

As also shown in FIG. 1, the drive systems are configured such that the front electric motor 22 drives the front wheels (not shown), and the left rear electric motor 32L and right rear electric motor 32R drive the rear wheels (not shown). However, embodiments are not so limited, as there may be any number of drive systems and/or motors at various locations (e.g., a motor driving each wheel, twin motors per axle, etc.). In addition, embodiments are not limited to a dual drive system, as embodiments can be used with a vehicle having any number of motors and/or power inverters.

In the propulsion system 16, the front drive unit 20, left rear drive unit 30L and right rear drive unit 30R are electrically connected to the battery system 40. The battery system 40 may also be electrically connected to other electrical components (also referred to as “electrical loads”), such as vehicle electronics (e.g., via an auxiliary power module or APM 42), heaters, cooling systems and others. The battery system 40 may be configured as a rechargeable energy storage system (RESS).

In an embodiment, the battery system 40 includes a plurality of separate battery assemblies, in which each battery assembly can be independently charged and can be used to independently supply power to a drive system or systems. For example, the battery system 40 includes a first battery assembly such as a first battery pack 44 connected to the front inverter 24, and a second battery pack 46. The first battery pack 44 includes a first plurality of battery modules 48, and the second battery pack 46 includes a second plurality of battery modules 50. Each of the first plurality of battery modules 48 and the second plurality of battery modules 50 includes a number of individual cells (not shown).

Each of the front electric motor 22 and the left rear electric motor 32L and right rear electric motor 32R is a three-phase motor having three phase motor windings. However, embodiments described herein are not so limited. For example, the motors may be a four-phase motor or any poly-phase machines supplied by poly-phase inverters, and the drive units can be realized using a single machine having independent sets of windings.

The battery system 40 and/or the propulsion system 16 includes a switching system having various switching devices for controlling operation of the first battery pack 44 and second battery pack 46 and for selectively connecting the first battery pack 44 and second battery pack 46 to the front drive unit 20, left rear drive unit 30L and right rear drive unit 30R. The switching devices may also be operated to selectively connect the first battery pack 44 and the second battery pack 46 to a charging system. The charging system can be used to charge the first battery pack 44 and the second battery pack 46, and/or to supply power from the first battery pack 44 and/or the second battery pack 46 to charge another energy storage system (e.g., vehicle-to-vehicle (V2V) and/or vehicle-to-everything (V2X) charging). The charging system includes one or more charging modules. For example, a first onboard charging module (OBCM) 52 is electrically connected to a charge port 54 for charging to and from an AC system or device, such as a utility AC power supply. A second OBCM 53 may be included for direct current (DC) charging (e.g., DC fast charging or DCFC).

In an embodiment, the switching system includes a first switching device 60 that selectively connects to the first battery pack 44 to the front inverter 24, left rear inverter 34L and right rear inverter 34R, and a second switching device 62 that selectively connects the second battery pack 46 to the front inverter 24, left rear inverter 34L and right rear inverter 34R. The switching system also includes a third switching device 64 (also referred to as a “battery switching device”) for selectively connecting the first battery pack 44 to the second battery pack 46 in series.

Any of various controllers can be used to control functions of the battery system 40, the switching system and the drive units. A controller 65 includes any suitable processing device or unit, and may use an existing controller such as a drive system controller, an RESS controller, and/or controllers in the drive system. For example, a controller 65 may be included for controlling switching and drive control operations as discussed herein.

The controller 65 may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller 65 may also include a non-transitory computer-readable medium that stores instructions which are processed by one or more processors of the controller to implement processes detailed herein.

The vehicle 10 also includes a computer system 55 that includes one or more processing devices 56 and a user interface 58. The computer system 55 may communicate with the charging system controller, for example, to provide commands thereto in response to a user input. The various processing devices, modules and units may communicate with one another via a communication device or system, such as a controller area network (CAN) or transmission control protocol (TCP) bus.

As illustrated herein, the vehicle 10 is an electric vehicle. In an alternative embodiment, the vehicle 10 can be an internal combustion engine vehicle, a hybrid vehicle, etc.

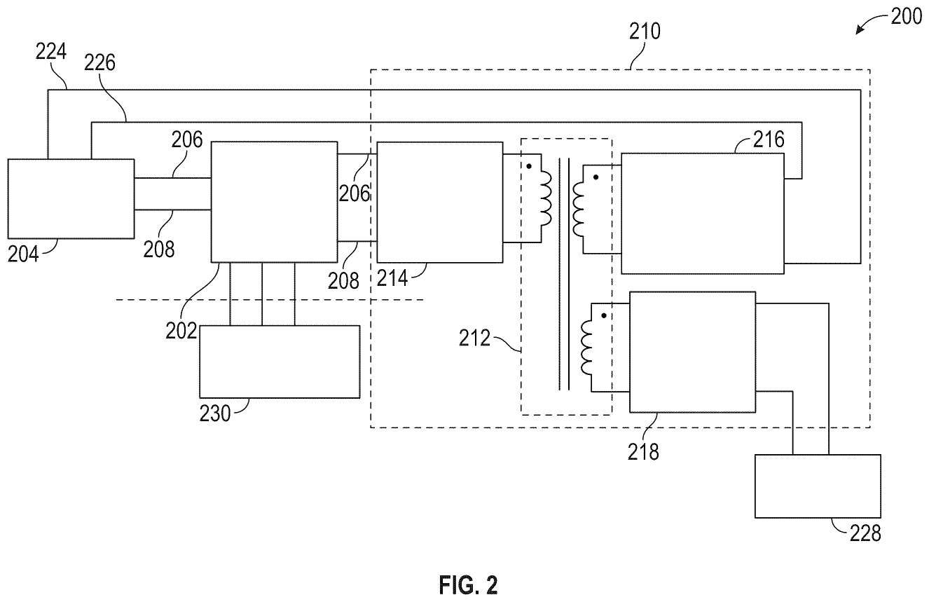

FIG. 2 is a schematic diagram of an electrical system 200 of the vehicle 10 of FIG. 1. The electrical system 200 includes a motor/inverter system 202 electrically coupled to a high voltage power source such as a high voltage battery (HV battery 204). The HV battery 204 can be a 400V class or 800V class battery, etc. The HV battery 204 is connected via a positive high voltage bus (positive HV bus 206) and a negative high voltage bus (negative HV bus 208). During propulsion of the vehicle 10, the HV battery 204 supplies power to the motor/inverter system 202.

An output of the motor/inverter system 202 is coupled to a multiport bidirectional direct current/direct current (DC/DC) converter 210. The multiport bidirectional DC/DC converter 210 includes three bidirectional AC/DC converters, each having their AC sides coupled to a transformer 212. The transformer 212 operates at high frequencies. In various embodiments, this high frequency range of operation is about 20 kHz, 200 kHz, 50-500 kHz, a few hundred kHz, etc.

The multiport DC/DC converter 210 includes a first AC/DC converter 214, a second AC/DC converter 216, and a third AC/DC converter 218. The first AC/DC converter 214 has a first DC-side coupled to the HV battery 204 via a positive HV bus 206 and the negative HV bus 208 and a first AC-side coupled to the transformer 212. The second AC/DC converter 216 forms an On Board Charging Module (OBCM). The second AC/DC converter 216 has a second DC-side coupled to the HV battery 204 via the positive OBCM bus 224 and a negative OBCM bus 226 and a second AC-side coupled to the transformer 212. The OBCM determines a maximum possible charge rate of the HV battery 204 while the vehicle is connected to an alternating current grid (AC grid 230). The OBCM is coupled to the HV battery 204 via a positive OBCM bus 224 and a negative OBCM bus 226. The third AC/DC converter 218 forms an Auxiliary Power Module (APM). The third AC/DC converter 218 has a third DC-side coupled to a low voltage power source (such as low voltage battery 228) and a third AC-side coupled to the transformer 212. The low voltage battery 228 can be +12V, +48V, etc.

In alternative embodiments, the multiport DC/DC converter 210 can include additional elements connected to the transformer 212, such as additional low voltage elements.

The motor/inverter system 202 can be coupled to an AC grid 230, which can be a 1-phase AC grid or a 3-phase AC grid. The AC grid 230 can be used to power the HV battery 204 via the OBCM.

The multiport DC/DC converter 210 is bidirectional. Therefore, the each of the first AC/DC converter 214, second AC/DC converter 216, and third AC/DC converter 218 are bidirectional. In one mode of operation, power is input via the first AC/DC converter 214 and is output via the second AC/DC converter 216 and the third AC/DC converter 218. In another mode of operation, power is input via the second AC/DC converter 216 and is output via the first AC/DC converter 214 and the third AC/DC converter 218. In yet another mode of operation, power is input via the third AC/DC converter 218 and is output via the first AC/DC converter 214 and the second AC/DC converter 216.

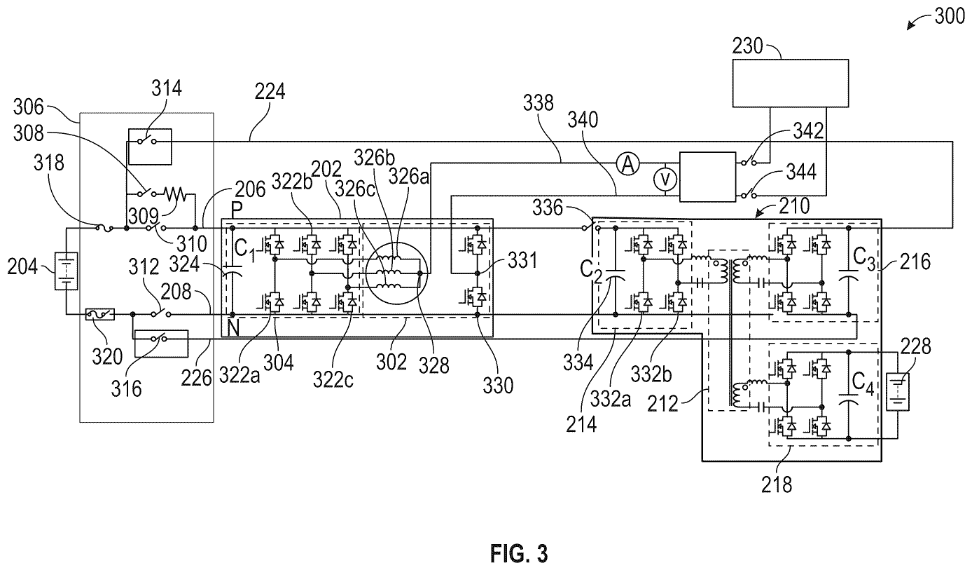

FIG. 3 is a detailed view of an electrical system 300 of the vehicle 10, in one embodiment. The motor/inverter system 202 includes a motor 302 and an inverter 304. The inverter 304 is electrically coupled between the HV battery 204 and the motor 302 via the positive HV bus 206 and the negative HV bus 208. The HV battery 204 is also electrically coupled to the second AC/DC converter 216 (OBCM) via the positive OBCM bus 224 and the negative OBCM bus 226.

The positive HV bus 206 and the negative HV bus 208 pass through a battery disconnect unit 306 which includes switches for controlling a connectivity between the HV battery 204 and the inverter 304. The positive OBCM bus 224 and the negative OBCM bus 226 also pass through the battery disconnect unit 306.

The battery disconnect unit 306 includes a positive HV switch 310 located along the positive HV bus 206. A pre-charge switch 308 and a pre-charge resistor 309 are in parallel with the positive HV switch 310. A negative HV switch 312 is located along the negative HV bus 208. The battery disconnect unit 306 also includes a positive OBCM switch 314 along the positive OBCM bus 224 and a negative OBCM switch 316 located along the negative OBCM bus 226. The positive HV bus 206 includes a main switch 318, while the negative HV bus 208 includes a pyro switch 320.

The inverter 304 includes a first phase leg 322a, a second phase leg 322b and a third phase leg 322c. Each phase leg connects between the positive HV bus 206 and the negative HV bus 208 and includes two switches in series. A midpoint is located between the switches. A capacito 324 (C₁) also extends between the positive HV bus 206 and the negative HV bus 208. The switches of each phase leg are separated by a midpoint. The motor includes three phase wires 326a, 326b, 326c. Each phase wire is associated with a respective phase leg of the inverter 304 and is coupled to the midpoint of the respective phase leg. The motor 302 is a three-terminal motor having a neutral point 328. The motor 302 includes a half-bridge synchronous rectifier 330 extending between the positive HV bus 206 and the negative HV bus 208. The half-bridge synchronous rectifier 330 includes two switches in series defining a midpoint 331.

The first AC/DC converter 214 includes a first phase leg 332a, a second phase leg 332b and a capacitor 334 (C₂), all of which connect between the positive HV bus 206 and the negative HV bus 208. A first converter switch 336 is located along the positive HV bus 206 and can be opened to electrically separate the motor 302 from the multiport DC/DC converter 210 (i.e., separate the half-bridge synchronous rectifier 330 from the capacitor 334 (C₂), first phase leg 332a and second phase leg 332b of the first AC/DC converter 214). The first converter switch 336 can be opened during a propulsion mode and can be closed to connect the motor 302 to the multiport DC/DC converter 210 for various charging modes.

The AC grid 230 includes a positive grid bus 338 and a negative grid bus 340. A first grid switch 342 is located on the positive grid bus 338 and a second grid switch 344 is located in the negative grid bus 340. The positive grid bus 338 and the negative grid bus 340 can be connected to the motor 302 as well as to various locations of the electrical system 300. The first grid switch 342 and the second grid switch 344 can be opened and/or closed to control a connectivity between the AC grid 230 and the electrical system 300. In the electrical system 300, the positive grid bus 338 can be coupled to the neutral point 328 of the motor and the negative grid bus 340 can be coupled to the midpoint 331 of the half-bridge synchronous rectifier 330.

The electrical system 300 can be operated in four modes: an APM charging mode (pre-charging mode), an HV battery charging mode, and a V2X mode (vehicle-to-everything mode) and a propulsion mode.

In the pre-charging mode, the first converter switch 336 is closed while the positive OBCM switch 314 and the negative OBCM switch 316 are opened. The positive HV switch 310 and the negative HV switch 312 are open. The first grid switch 342 and the second grid switch 344 are left open to disconnect the AC grid 230 from the motor 302. In this configuration, the low voltage battery 228 (via the APM) provides power to the first AC/DC converter 214 and to the inverter 304, thereby charging the capacitor 324 (C₁) as well as the capacitor 334 (C₂). Since the APM can be used to pre-charge the capacitors, the pre-charge switch 308 and pre-charge resistor 309 are unnecessary for pre-charging. The electrical system 300 can therefore be manufactured without the pre-charge switch 308 and the pre-charge resistor 309. However, the pre-charge switch 308 and the pre-charge resistor 309 can be included in the electrical system 300 if it is desired to perform pre-charging using these elements.

In a charging mode, the first grid switch 342 and the second grid switch 344 are closed to connect the positive grid bus 338 of the AC grid 230 to the neutral point 328 of the motor 302 and the negative grid bus 340 of the AC grid 230 to the midpoint 331 of the half-bridge synchronous rectifier 330. In the charging mode, the positive HV switch 310 and the negative HV switch 312 are opened. The first converter switch 336, the positive OBCM switch 314 and the negative OBCM switch 316 are closed. The inverter 304 acts as a power factor correction device. Power from the AC grid 230 is supplied through the OBCM to charge the HV battery 204. The power also can be used to charge the low voltage battery 228 via the APM while the HV battery 204 is being charged. The multiport DC/DC converter 210 can use phase shifted pulse width modulation (PWM) and/or resonant control to direct achieve power flow as desired (i.e., to either the OBCM, the APM or both).

In a V2X mode, the first grid switch 342 and the second grid switch 344 are closed to connect the positive grid bus 338 of the AC grid 230 to the neutral point 328 of the motor 302 and the negative grid bus 340 of the AC grid 230 to the midpoint 331 of the half-bridge synchronous rectifier 330. The positive HV switch 310 and negative HV switch 312 are open, while positive OBCM switch 314, the negative OBCM switch 316 and first converter switch 336 are closed. Since the multiport DC/DC converter 210 is bi-directional, the HV power is passed along the positive OBCM bus 224 and the negative OBCM bus 226 into the multiport DC/DC converter 210 to provide a DC voltage at the first AC/DC converter 214. The inverter 304 then is operated based on this DC voltage to provide an AC output that can be supplied to the AC grid 230 or any other device electrically coupled to the vehicle 10. The AC output can be at any suitable frequency, such as 60 Hz. The inverter 304 can be used as a power factor correction device.

In a propulsion mode, the first converter switch 336, the positive OBCM switch 314 and the negative OBCM switch 316 are open. The positive HV switch 310 and negative HV switch 312 are closed. The AC grid 230 is disconnected from the electrical system (i.e., first grid switch 342 and second grid switch 344 are open).

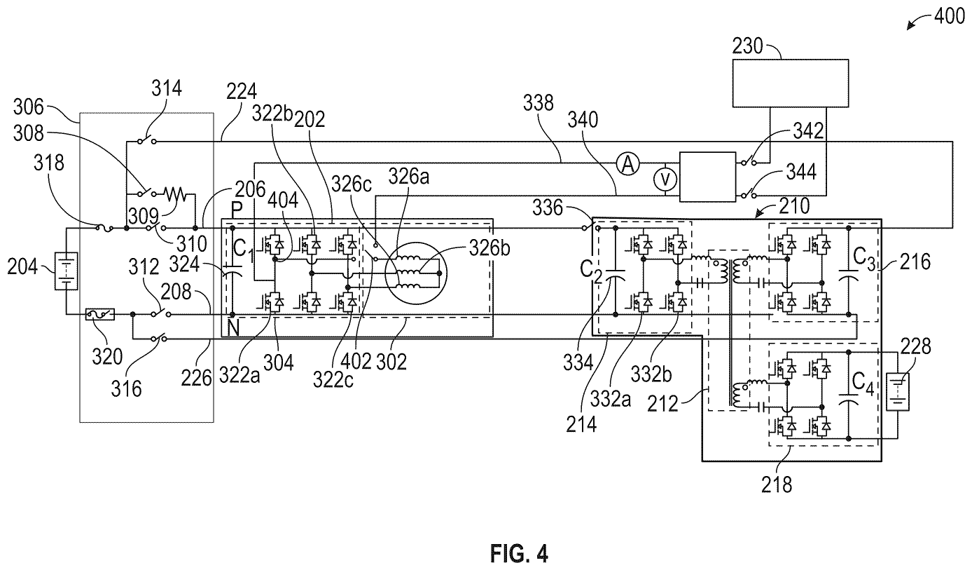

FIG. 4 is a detailed view of an electrical system 400 of the vehicle, in another embodiment. The electrical system 400 does not include the half-bridge synchronous rectifier 330 shown in FIG. 3. The AC grid 230 connects to the electrical system 400 via one of the phase legs of the inverter 304. For illustrative purposes, the first phase wire 326a of the motor 302 includes a switch 402 between the motor and the midpoint 404 of the first phase leg 322a. The positive grid bus 338 is connected to the midpoint 404 of the first phase leg 322a and the negative grid bus 340 is connected to the switch 402. The switch 402 is placed in an open configuration to connect the AC grid 230 to the motor 302 and is placed in a closed configuration to disconnect the AC grid from the motor and instead in a condition suitable for a propulsion mode.

For each of the various modes of operation of the electrical system 400, the positive HV switch 310, negative HV switch 312, positive OBCM switch 314, negative OBCM switch 316, the first converter switch 336, the first grid switch 342 and second grid switch 344 operate the same way as discussed with respect to the electrical system 300 of FIG. 3.

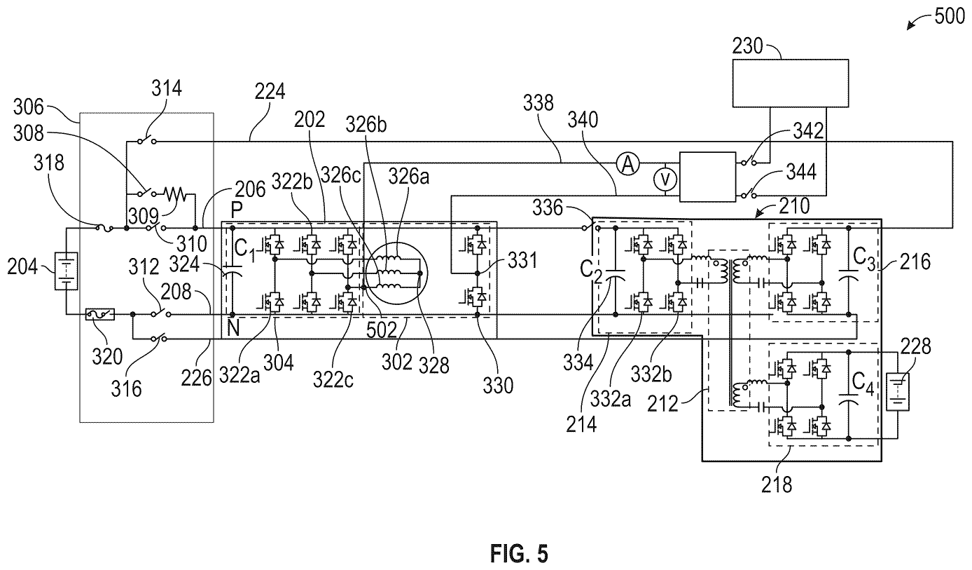

FIG. 5 is a detailed view of an electrical system 500 of the vehicle 10, in yet another embodiment. The electrical system 500 includes the half-bridge synchronous rectifier 330 that is shown in FIG. 3. The AC grid 230 connects to the electrical system 500 via one of the phase legs of the inverter 304 and the half-bridge synchronous rectifier 330. For illustrative purposes, the positive grid bus 338 is connected to the midpoint 502 of the third phase leg 322c and the negative grid bus 340 is connected to the midpoint 331 of the half-bridge synchronous rectifier 330.

For each of the various modes of operation of the electrical system 500, the positive HV switch 310, negative HV switch 312, positive OBCM switch 314, negative OBCM switch 316, the first converter switch 336, the first grid switch 342 and second grid switch 344 operate the same way as discussed with respect to the electrical system 300 of FIG. 3.

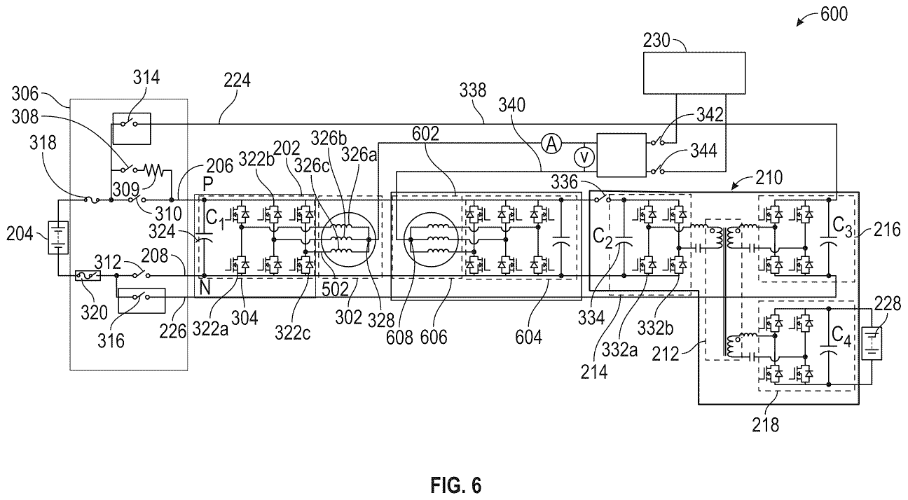

FIG. 6 is a detailed view of an electrical system 600 of the vehicle 10, in yet another embodiment. The electrical system 600 does not include the half-bridge synchronous rectifier 330 shown in FIG. 3. Instead, the electrical system 600 includes a first motor inverter system (i.e., motor/inverter system 202) and a second motor/inverter system 602. The second motor/inverter system 602 has a second inverter 604 and a second motor 606. The second motor/inverter system 602 is coupled to the positive HV bus 206 and the negative HV bus 208 in the same configuration as is the motor/inverter system 202. A first motor (i.e., motor 302) and the second motor 606 can be a 4-phase electrical motor. The first motor (i.e., motor 302) includes a first neutral point (i.e., neutral point 328) and the second motor 606 includes a second neutral point 608. To connect the AC grid 230 to the vehicle, the positive grid bus 338 connects to the first neutral point (i.e., neutral point 328) and the negative grid bus 340 connects to the second neutral point 608.

For each of the various modes of operation of the electrical system 400, the positive HV switch 310, negative HV switch 312, positive OBCM switch 314, negative OBCM switch 316, the first converter switch 336, the first grid switch 342 and second grid switch 344 operate the same way as discussed with respect to the electrical system 300 of FIG. 3.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. An electrical system of a vehicle, comprising:
a motor configured to couple to an alternating current (AC) grid;
a multi-port direct current/direct current (DC/DC) converter, including:
a transformer;
a first alternating current/direct current (AC/DC) converter having a first DC-side configured to couple to a high voltage power source and a first AC-side coupled to the transformer;
a second AC/DC converter having a second AC-side coupled to the transformer and a second DC-side configured to couple to the high voltage power source;
a third AC/DC converter having a third AC-side coupled to the transformer and a third DC-side coupled to a low voltage power source; and
a processor configured to control a configuration between the motor, the multi-port DC/DC converter and the AC grid.

2. The electrical system of claim 1, wherein the motor further comprises a neutral point and a half-bridge synchronous rectifier including a midpoint, wherein the neutral point is configured to connect to a positive grid bus of the AC grid and the midpoint is configured to connect to a negative grid bus of the AC grid.

3. The electrical system of claim 1, wherein the motor includes a first phase wire configured to connect to a positive grid bus of the AC grid and an inverter including a first phase leg associated with the first phase wire, wherein the first phase leg is configured to connect to negative grid bus of the AC grid.

4. The electrical system of claim 1, wherein the motor includes a first phase wire configured to connect to a positive grid bus of the AC grid and a half-bridge synchronous rectifier having a midpoint, wherein the midpoint is configured to connect to a negative grid bus of the AC grid.

5. The electrical system of claim 1, wherein the motor includes a first motor having a first neutral point and a second motor having a second neutral point, wherein the first neutral point is configured to connect to a positive grid bus of the AC grid and the second neutral point is configured to connect to a negative grid bus of the AC grid.

6. The electrical system of claim 1, further comprising a first converter switch between the high voltage power source and the first AC/DC converter, a positive On-Board Chargin Module (OBCM) switch and a negative OBCM switch between the third AC/DC converter and the high voltage power source, a positive high voltage (HV) switch and a negative HV switch between the high voltage power source and the motor, and a first grid switch and second grid switch of the AC grid.

7. The electrical system of claim 6, wherein, in a propulsion mode, the first converter switch, the positive OBCM switch and the negative OBCM switch are open and the positive HV switch and the negative HV switch are closed.

8. The electrical system of claim 6, wherein, in a pre-charging mode, the OBCM positive switch, the OBCM negative switch are open, and the first converter switch, the positive HV switch and the negative HV switch are closed.

9. The electrical system of claim 6, wherein, in a charging mode, the positive HV switch and the negative HV switch are open, and the first converter switch, the positive OBCM switch, the negative OBCM switch, the first grid switch and second grid switch are closed.

10. The electrical system of claim 6, wherein in a vehicle-to-everything mode, the positive HV switch and negative HV switch 312 are open, and the first converter switch, the positive OBCM switch and the negative OBCM switch are closed.

11. An electric vehicle, comprising:
a high voltage power source;
a low voltage power source;
an inverter coupled to the high voltage power source;
a motor coupled to the inverter, wherein the motor is configured to couple to an alternating current (AC) grid;
a multi-port direct current/direct current (DC/DC) converter, including:
a transformer;
a first alternating current/direct current (AC/DC) converter having a first DC-side configured to couple to the high voltage power source and a first AC-side coupled to the transformer;
a second AC/DC converter having a second AC-side coupled to the transformer and a second DC-side configured to couple to the high voltage power source;
a third AC/DC converter having a third AC-side coupled to the transformer and a third DC-side coupled to the low voltage power source; and
a processor configured to control a configuration between the motor, the multi-port DC/DC converter and the AC grid.

12. The electric vehicle of claim 11, wherein the motor further includes a neutral point and a half-bridge synchronous rectifier including a midpoint, wherein the neutral point is configured to connect to a positive grid bus of the AC grid and the midpoint is configured to connect to a negative grid bus of the AC grid.

13. The electric vehicle of claim 11, wherein the motor includes a first phase wire configured to connect to a positive grid bus of the AC grid and the inverter includes a first phase leg associated with the first phase wire, wherein the first phase leg is configured to connect to negative grid bus of the AC grid.

14. The electric vehicle of claim 11, wherein the motor includes a first phase wire configured to connect to a positive grid bus of the AC grid and a half-bridge synchronous rectifier having a midpoint, the midpoint configured to connect configured to connect to a negative grid bus of the AC grid.

15. The electric vehicle of claim 11, wherein the motor includes a first motor having a first neutral point and a second motor having a second neutral point, wherein the first neutral point is configured to connect to a positive grid bus of the AC grid and the second neutral point is configured to connect to a negative grid bus of the AC grid.

16. The electric vehicle of claim 11, further comprising a first converter switch between the high voltage power source and the first AC/DC converter, a positive On-Board Chargin Module (OBCM) switch and a negative OBCM switch between the third AC/DC converter and the high voltage power source, a positive high voltage (HV) switch and a negative HV switch between the high voltage power source and the motor, and a first grid switch and second grid switch of the AC grid.

17. The electric vehicle of claim 16, wherein, in a propulsion mode, the first converter switch, the positive OBCM switch and the negative OBCM switch and are open and the positive HV switch and the negative HV switch are closed.

18. The electric vehicle of claim 16, wherein, in a pre-charging mode, the OBCM positive switch, the OBCM negative switch are open, and the first converter switch, the positive HV switch and the negative HV switch are closed.

19. The electric 'vehicle of claim 16, wherein, in a charging mode, the positive HV switch and the negative HV switch are open, and the first converter switch, the positive OBCM switch, the negative OBCM switch, the first grid switch and second grid switch are closed.

20. The electric vehicle of claim 16, wherein in a vehicle-to-everything mode, the positive HV switch and negative HV switch 312 are open, and the first converter switch, the positive OBCM switch and the negative OBCM switch are closed.
